(19) United States
(12) Patent Application Publication
(10) Pub. No.: US 2021/0123887 A1
(43) Pub. Date: Apr. 29, 2021

(54) ANALYSIS DEVICE AND METHOD FOR ANALYZING SUBSTANCES USING ION-MOBILITY SPECTROMETRY

(71) Applicant: GOTTFRIED WILHELM LEIBNIZ UNIVERSITÄT HANNOVER, Hannover (DE)

(72) Inventors: Stefan ZIMMERMANN, Burgwedel (DE); Ansgar KIRK, Hannover (DE); Christian-Robert RADDATZ, Hannover (DE); Christian THOBEN, Hannover (DE)

(21) Appl. No.: 17/057,145

(22) PCT Filed: May 22, 2019
(86) PCT No.: PCT/EP2019/063173

§ 371 Date: Nov. 20, 2020

(30) Foreign Application Priority Data
May 23, 2018 (DE) 10 2018 112 349.3

(51) Int. Cl. G01N 27/622

(52) U.S. Cl. CPC G01N 27/622

(57) ABSTRACT

The invention relates to an analysis device for analyzing substances using ion-mobility spectrometry. The analysis device has the following features: a) an ion-mobility spectrometer with a reaction chamber and a drift chamber, a switchable ion gate being arranged between the reaction chamber and the drift chamber, b) a first field-generating device of the ion-mobility spectrometer, said field-generating device being designed to generate an electric field in the reaction chamber in order to produce a movement of analyte ions, which can be differentiated by ion-mobility spectrometry, towards the ion gate, c) an electrospray device which has an electrospray source, wherein the electrospray device is designed to spray a liquid supplied to the electrospray device into the reaction chamber in the form of a mist via the electrospray source, said liquid having a substance which is to be analyzed and a solvent, and d) an evaporation device which is designed to evaporate the solvent contained in the sprayed mist within the reaction chamber, said evaporation device being formed by the first field-generating device. The invention additionally relates to a method for analyzing substances using ion-mobility spectrometry.

The invention relates to field of analyzing substances by ion mobility spectrometry. Such a method and a gas analysis device are known from WO 2015/091146 A1. Quick and highly sensitive trace gas analysis is rendered possible by ion mobility spectrometry, within the scope of which substances are able to be separated and identified on the basis of the movement of their ions through a neutral gas under the influence of an electric field. Consequently, this separation requires the ions to be separated, which are also referred to as analyte ions below, to be present in the gaseous phase. In many cases, the substances to be analyzed are sufficiently volatile in any case or are available as gaseous material in any case. However, this represents an increasing limitation with increasing molecule size of the substances to be analyzed.

The invention is therefore based on the object of also analyzing other substances, not already available in gaseous form, by ion mobility spectrometry.

This object is achieved by an analysis device for analyzing substances by ion mobility spectrometry as claimed in claim 1. The analysis device comprises the following features:
a) an ion mobility spectrometer with a reaction chamber and a drift chamber, wherein a switchable ion gate is arranged between the reaction chamber and the drift chamber,
b) a first field generating device of the ion mobility spectrometer, which is configured to generate an electric field in the reaction chamber for the purposes of generating a movement of analyte ions, which are able to be differentiated by ion mobility spectrometry, toward the ion gate,
c) an electrospray device which comprises an electrospray source, wherein the electrospray device is configured to spray a liquid into the reaction chamber in nebulized form, said liquid being supplied to the electrospray device by the electrospray source and comprising a substance to be analyzed and a solvent,
d) an evaporation device which is configured to exclusively or predominantly carry out the evaporation of the solvent contained in the sprayed-in mist within the reaction chamber, wherein the evaporation device is formed by the first field generating device.

Accordingly, analyte ions that are separable by ion mobility spectrometry can be provided in the reaction chamber by way of electrospray ionization. In so doing, electrospray ionization offers advantages over other methods, such as a thermal evaporation of the substance to be analyzed, for example. By way of example, thermal evaporation would lead to the decomposition of many substances before these form a sufficient vapor pressure, and so a meaningful analysis by ion mobility spectrometry is no longer possible.

Applications already exist for the use of electrospray ionization, for example in the field of mass spectrometry. However, such proposals are unsuitable for ion mobility spectrometry, for example because the approaches presented therein do not allow for a sufficiently fast evaporation of the solvent. However, incomplete evaporation of the solvent leads to “impure” analyte ions, and so the analysis by ion mobility spectrometry leads to inadequate results and consequently reduces the analytical performance.

By contrast, the present invention optimizes electrospray ionization for the field of ion mobility spectrometry. Advantageously, this is implemented by virtue of the evaporation device, which serves to evaporate the solvent contained in the sprayed-in mist, being formed by the first field generating device of the ion mobility spectrometer. The solvent contained in the sprayed-in mist is exclusively or predominantly evaporated within the reaction chamber by means of this evaporation device. In this way, it is possible to implement a complete evaporation of the solvent, or at least an evaporation of the solvent that is adequate for a meaningful analysis, within the reaction chamber, to be precise without particular additional outlay such as, for example, the additional introduction of the heated gas into the reaction chamber. The first field generating device is required for the function of the ion mobility spectrometer in any case. If this first field generating device is operated at a comparatively high field strength, an amount of energy, specifically in the form of kinetic energy, can be supplied to the particles contained in the sprayed-in the mist, said energy sufficing for the aforementioned evaporation process of the solvent. In particular, it is advantageous to operate the first field generating device with a high field strength in relation to the particle density. Hence, a higher mean energy can be supplied by the first field generating device to the particles contained in the sprayed-in mist than to the gas surrounding the particles.

Accordingly, the analysis device according to the invention can have a comparatively simple structure. The analysis device can be embodied without a separate heating device for heating the sprayed-in mist in the reaction chamber. This allows the provision of a cost-effective and small-scale analysis device for ion mobility spectrometry, even for the analysis of substance with a relatively large molecule size. Therefore, the analysis device can also be employed for mobile use.

A further advantage is that unwanted interference effects can be avoided by avoiding an additional heating of the substances in the ion mobility spectrometer. Thus, the ion mobility, i.e., the separation size in the detector, depends on the temperature. Actually unwanted thermal heating of the analyte ions can lead to a shift in the signals and consequently to a reduction in the analytical performance of the analysis device.

In the process, effective (fictitious) ion temperatures of more than 2000 K can be reached as a result of the energy supplied to the reaction chamber by means of the electric field. Such temperatures would not be achievable by pure heating of, e.g., a drift gas, both on account of extremely high energy requirements and on account of the fact that there are no suitable materials available for designing the corresponding parts of the ion mobility spectrometer for such high temperatures.

Consequently, the invention allows the combination of a low technical realization outlay for the analysis device with comparatively high fictitious evaporation temperatures, and so a significantly improvement in the detection of substances that are difficult to evaporate is facilitated, particularly in the field of in situ analysis. Such substances to be analyzed can be, for example, a relatively large biomolecules, e.g., proteins, fats, sugar. By way of example, methanol and/or water can be used as a solvent. The electrospray source can be a needle-shaped source, for example.

According to an advantageous development of the invention, the electrospray source is embodied as a nanospray source, by means of which the supplied liquid is able to be sprayed in nebulized fashion in the form of nanodroplets into the reaction chamber. This facilitates a particularly fine distribution of the supplied liquid in the form of the nanodroplets. Moreover, as a result of the comparatively small capillary diameter of the nanospray source, there is no evaporation of the solvent within the electrospray source, even under vacuum conditions; instead, this evaporation only occurs within the reaction chamber as desired. By way of example, the nanospray source can be embodied with an outlet a diameter of no more than 15 μm or no more than 1 μm.

According to an advantageous development of the invention, the electrospray device comprises a voltage source which electrically feeds the electrospray source, wherein the voltage source generates a DC voltage, an AC voltage or a superposition of a DC voltage and an AC voltage. In this way, the electrospray device can be operated with the voltage most suitable for the respective application.

According to an advantageous development of the invention, the analysis device comprises a negative pressure generating device, which is configured to generate negative pressure in relation to atmospheric pressure, at least in the reaction chamber. Here, the negative pressure generating device can be coupled to the reaction chamber either directly or indirectly, e.g., via another chamber of the ion mobility spectrometer. In principle, the negative pressure generating device can have any design, e.g., it can be in the form of the pump, e.g., a diaphragm pump, a rotary vane pump or any other pump, or in the form of a fan or a compressor. The negative pressure to be generated in relation to the atmospheric pressure need not assume an extremely large pressure difference with respect to said atmospheric pressure, in particular it need not be in the range of pressure values which are usually referred to as a high vacuum and are required in the case of a mass spectrometer, for example. According to the invention, a negative pressure ranging from 2 mbar to 100 mbar (absolute pressure) is generated by the negative pressure generating device. The upper limit of the negative pressure range can also be set to be higher, e.g., at 200, 300 or 400 mbar. This is advantageous in that the gas analysis device can be realized using simple cost-effective components. In particular, the negative pressure generating device can be realized using conventional, commercially available products.

Moreover, the generation of the negative pressure in the reaction chamber is conducive to spraying in the supplied liquid and the operation of the solvent within the reaction chamber. The negative pressure reduces, firstly, the evaporation temperature and, secondly, the required electric field strength of the first field generating device.

The first field generating device can be arranged at or in the reaction chamber, or at least in the region of the reaction chamber, such that the desired electric field can be generated within the reaction chamber. In particular, the first field generating device can be configured to generate an electric field with a potential drop from an ionization source-side region of the reaction chamber in the direction of an ion gate.

Apart from the explained modifications, the gas analysis device and, in particular, the ion mobility spectrometer thereof can otherwise have a design like known ion mobility spectrometers. In particular, the gas analysis device or the ion mobility spectrometer thereof can comprise at least the following components:
a) an ionization source region with an ionization source, i.e., the electrospray source in this case,
b) the reaction chamber, which is coupled to the ionization source region,
c) a drift chamber comprising a drift gas supply connector, which is connected to a gas supply line for supplying drift gas to the drift chamber,
d) a switchable ion gate between the reaction chamber and the drift chamber,
e) an ion detector at the end of the drift chamber distant from the ion gate,
f) a second field generating device, which is configured to generate an electric field in the drift chamber.

The second field generating device can be arranged at or in the drift chamber, or at least in the region of the drift chamber, such that the desired electric field can be generated within the drift chamber. In particular, the second field generating device can be configured to generate an electric field with a potential drop from the ion gate in the direction of the ion detector.

The first and/or the second field generating device can comprise electrodes, e.g., ring electrodes arranged in the reaction chamber of the drift chamber, said electrodes being arranged in succession in the direction of the desired potential drop of the electric field to be generated, for example. The first and/or the second field generating device might also be formed by a single electrode that extends in the direction of the desired potential drop, said single electrode being produced from a material with a relatively high electrical resistivity, for example in the form of a uniform ring electrode. As a consequence of the relatively high resistance, the desired electric field can also be generated along the longitudinal direction, i.e., along the desired movement direction of the ions. Thus, such a uniform ring electrode can be formed by a cylinder made of conductive glass, for example. The first and/or the second field generating device can also have combinations of the aforementioned types of electrodes.

The ion gate serves as a temporary barrier for the analyte ions on their path from the reaction chamber to the drift chamber. By way of example, the ion gate is operated in pulsed fashion according to a certain temporal pattern, in such a way that it is opened and closed and analyte ions reach the drift chamber from the reaction chamber during the open phases. As a result, defined, mutually separated measurement cycles of the gas analysis device can be specified in accordance with the switching cycle of the ion gate.

The ion gate can be embodied in accordance with the ion gates of known ion mobility spectrometers, for example with two electrodes arranged in succession in the movement direction of the analyte ions or electrodes arranged nested within one another in one plane. According to an advantageous development of the invention, the ion gate comprises at least three electrodes arranged in succession in the direction from the reaction chamber to the drift chamber. Such an ion gate is highly efficient in terms of the barrier effect. A further advantage is that, as a result of the three successively arranged electrodes, the mutually adjacent electrodes can be respectively operated in pairs with an electric field with a field strength that corresponds to the field strength in the adjacent chamber, i.e., the reaction chamber on one side and the drift chamber on the other side. This is advantageous, in turn, in that the electric fields present in the reaction chamber and in the drift chamber can be left largely uninfluenced by the switching of the ion gate between the blocked and the open state. By way of example, the electrodes of the ion gate can be embodied as a ring electrodes or as grid electrodes.

According to an advantageous development of the invention, the negative pressure generating device is configured to generate a drift gas flow counter to the drift direction of the ions in the drift chamber. This is advantageous in that the drift gas required for carrying out the ion mobility spectrometry in any case can be guided through the drift chamber without requiring additional components. Rather, the negative pressure generating device can also be used to this end. As a result of the generated drift gas flow, fresh drift gas is continuously supplied and thus counteracts a contamination of the drift chamber by unwanted particles since the drift gas flow leads to flushing of the drift chamber. In the process, the drift gas can be purified and dried by filters.

As a matter of principle, the negative pressure generating device can be connected to different points of the gas analysis device or of a housing body of the ion mobility spectrometer. The reaction chamber can be pressure connected to the drift chamber in an advantageous embodiment of the invention; i.e., there is pressure equalization between the reaction chamber and the drift chamber. As a result, the prevailing pressure is substantially the same in the reaction chamber and in the drift chamber, apart from small pressure differences occurring as a result of the flow effects. Thus, for example, the negative pressure generating device can be connected to a extraction connector of the gas analysis device.

According to an advantageous development of the invention, the negative pressure generating device comprises a suction connector, which is connected to an extraction connector of the gas analysis device, said extraction connector being arranged upstream of the ion gate in the drift direction of the ions. Thus, the extraction connector can open into the reaction chamber or the ionization source region, for example. This is advantageous in that the drift gas flow can also be guided, in full or in part, through the reaction chamber. This also allows the reaction chamber to be cleaned from unwanted particles. This is to the benefit of, in turn, the sensitivity and measurement accuracy of the gas analysis device.

Moreover, the object set forth at the outset is also achieved by a method for analyzing substances by ion mobility spectrometry, wherein a liquid containing a substance to be analyzed and a solvent is supplied in nebulized form to a reaction chamber of an ion mobility spectrometer by means of electrospray ionization and the solvent is evaporated within the reaction chamber, wherein the solvent is exclusively or predominantly evaporated by an electric field generated in the reaction chamber , kinetic energy being supplied to the droplets of the sprayed-in mist in this way and consequently heating said droplets such that the solvent evaporates. The advantages explained above may also be achieved thereby. By way of example, the method can be carried out using an analysis device of the aforementioned type.

According to an advantageous development of the invention, the liquid is dispensed in nebulized form by an electrospray source exclusively or predominantly as a result of the electric field generated in the reaction chamber or in an additional region in front of the electrospray source. This is advantageous in that dispensing the liquid in nebulized form requires no additional devices such as, e.g., a pressure generating device, by means of which the liquid is dispensed by the electrospray source with a positive pressure. Therefore, this can also reduce the outlay for realizing the analysis device. Here, the liquid is dispensed droplet-by-droplet by the electrospray source. Charge carriers are already supplied to the droplets at the tip of the electrospray source, and so already charged droplets are dispensed into the reaction chamber, said droplets behaving like ions in respect of the electric field. Accordingly, the aforementioned high kinetic energy that ensures the evaporation of the solvent can already be supplied to these ionized droplets of the sprayed-in mist by way of a sufficiently strong electric field, which is generated by the first field generating device.

According to an advantageous development of the invention, the method is carried out under negative pressure in relation to the atmospheric pressure, at least in the reaction chamber. The advantages in respect of the negative pressure generation explained above may also be achieved thereby. Additionally, the negative pressure is conducive to dispensing the liquid from the electrospray source in nebulized form.

According to an advantageous development of the invention, the analyte ions to be analyzed by means of ion mobility spectrometry are freed from the solvent within the reaction chamber. A high analytical performance of the ion mobility spectrometry is achieved hereby.

The analysis device according to the invention can be used particularly advantageously using the operating parameters set forth below. The method according to the invention can also be operated accordingly. Here, the field strength of the electric field in the reaction chamber generated by the first field generating device is specified as field strength. The drift chamber can be operated with comparable field strengths. The pressure values specify the absolute pressure which is generated in the reaction chamber by the negative pressure generating device. A field strength ranging from 4 V/cm per mbar absolute pressure to 37.5 V/cm per mbar absolute pressure or ranging from 8 V/cm per mbar absolute pressure to 37.5 V/cm per mbar absolute pressure or ranging from 12.5 V/cm per mbar absolute pressure to 37.5 V/cm per mbar absolute pressure is advantageous. Here, the absolute pressure relates to the chosen negative pressure which the negative pressure generating device generates in the reaction chamber.

The invention will be explained in more detail below on the basis of exemplary embodiments using drawings.

In detail:

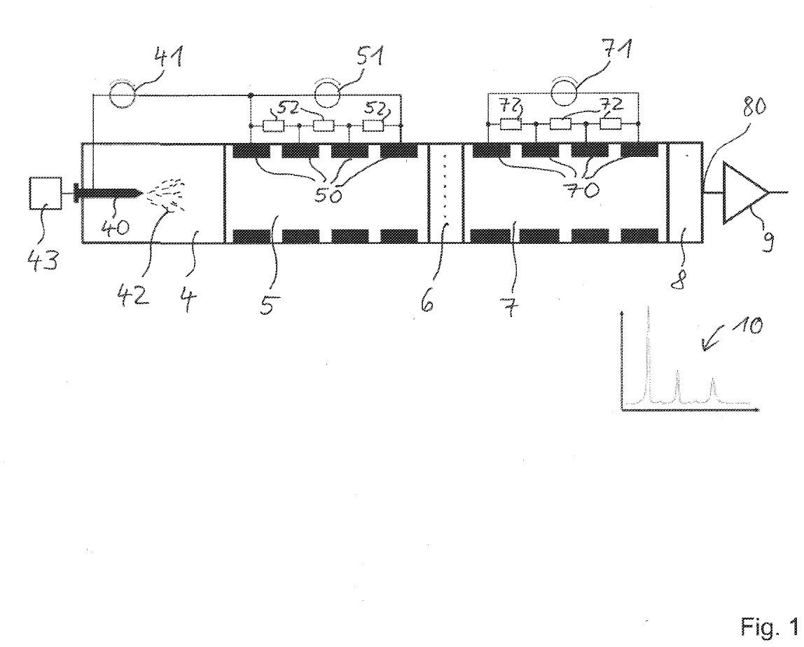

FIG. 1 shows a schematic illustration of the basic structure of an analysis device and

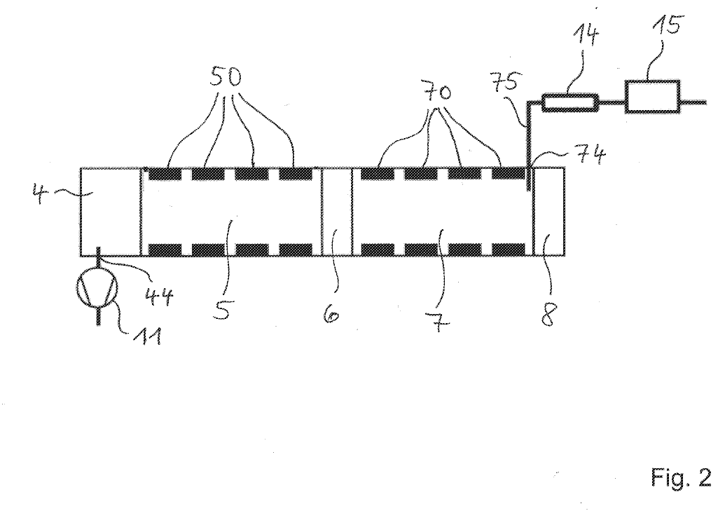

FIG. 2 shows further embodiment features of the analysis device as per FIG. 1.

Here, FIG. 1 shows the analysis device in respect to the structure and the electrical wiring while in FIG. 2 shows the same subject matter with regard to the connections of the pressure lines for generating negative pressure and the introduction of drift gas. In particular, a combination of the electrical wiring of FIG. 1 and the further features illustrated in FIG. 2 is advantageous.

The analysis device illustrated in FIG. 1 comprises an ion mobility spectrometer 2, which has the tubular or tube-shaped housing body 3. The housing body 3 is subdivided into an ionization source region 4, a reaction chamber 5, an ion gate 6, a drift chamber 7, and an ion detector 8, which are arranged in succession in the aforementioned sequence, as illustrated in FIG. 1. The ion detector 8, which can be embodied as, e.g., a Faraday detector, e.g., in a cup form or in the form of a metal plate, is connected to an amplifier 9 that is connected to an electrical connector 80 of the ion mobility spectrometer 2. The amplifier 9 amplifies the electric current supplied by the connector 80 and generated by the charges of the ions, and so a spectrogram 10 arises that the output of the amplifier 9. FIG. 1 further shows that electrodes 50, 70 of a first and second field generating device, respectively, are arranged in the reaction chamber 5 and in the drift chamber 7. In the illustrated exemplary embodiment, the electrodes 50, 70 are embodied as ring electrodes, which form a ring in the interior of the reaction chamber 5 or the drift chamber 7.

FIG. 1 moreover shows the electrical wiring of the reaction chamber 5 and of the drift chamber 7 for generating an electric field with a potential drop in the longitudinal direction of the housing body 3, i.e., from left to right. By way of example, the illustrated ring electrodes 50 might be connected to a voltage source 51 via a voltage divider circuit constructed from resistors 52. Accordingly, the electrodes 70 might be connected to a voltage source 71 via a voltage divider circuit constructed from resistors 72. Therefore, apart from the electrodes 50, the first field generating device, which is assigned to the reaction chamber 5, moreover comprises the voltage source 51 and the resistors 52. In addition to the electrodes 70, the second generating device, which is assigned to the drift chamber 7, moreover comprises a voltage source 71 and the resistors 72.

Here, the illustrated regions 4, 5, 6, 7, 8 of the ion mobility spectrometer 2 are interconnected, and so the analyte ions can move freely, or only under the control of electric fields and the ion gate 6, through the housing body 3.

The substance to be analyzed is supplied in the form of a liquid from a container 43. The liquid contains a substance to be analyzed and a solvent. This liquid is dispensed into the reaction chamber 5 or initially into the ionization source region 4 in the form of a sprayed-in mist 42 by way of an electrospray source 40, e.g., a needle-shaped electrospray source in the form of a nanospray source, which is arranged in the ionization source region 4. To this end, the electrospray source 40 is connected to a voltage source 41. Moreover, the voltage source 41 is connected to the closest electrode 50 of the first field generating device. The mist 42 contains very fine droplets of the liquid, which are charged at the tip of the electrospray source 40 and which then behave like ions so that these are accelerated by the electric field. The solvent evaporates in the process. The desired electrospray ionization is implemented in this way.

Consequently, a relatively strong electric field is generated in the reaction chamber 5 by the first field generating device, said electric field initially accelerating the charged droplets of the mist 42 and leading to the evaporation of the solvent and then further accelerating the remaining analyte ions such that these can be output, under the control of the ion gate 6, to the drift chamber 7 with a high kinetic energy.

FIG. 2 shows various further components of the gas analysis device 1 that are connected to the housing body 3 of the ion mobility spectrometer 2 by way of hollow conduits. An extraction connector 44, which is arranged on the housing body 3 in the ionization source region 4, but which could also be arranged, for example, in the region of the reaction chamber 5, is connected to a suction connector of the negative pressure generating device 11, e.g., a pump.

The housing body 3 further comprises a drift gas supply connector 74, which is connected to drift gas supply via a hollow conduit. As a matter of principle, various gases that are chemically/physically neutral with respect to the analyte ions can be used as a drift gas, for example nitrogen or a noble gas. As a consequence of the relatively high nitrogen content of the ambient air, the latter can also be used directly as drift gas, and so FIG. 2 only illustrates a connection to the ambient air. A mass flow regulator 15 can be disposed upstream of the drift gas supply connector 74, as a result of which the supply of the drift gas can be regulated and kept constant. Further, a filter 14 can be disposed upstream of the drift gas supply connector 74; this is advantageous, in particular, when using ambient gas as a drift gas in order to purify the latter.

The ionization source region 4, the reaction chamber 5, the region of the ion gate 6, and the drift chamber 7 can be pressure connected to one another; i.e., there is pressure equalization between these sections of the housing body 3. Thus, the desired negative pressure can be generated by the negative pressure generating device 11 and drift gas can be suctioned in through the drifted gas supply connector 74. All gases suctioned in are then extracted and discharged again by the negative pressure generating device 11.

1. An analysis device for analyzing substances by ion mobility spectrometry, comprising:
a) an ion mobility spectrometer with a reaction chamber and a drift chamber, wherein a switchable ion gate is arranged between the reaction chamber and the drift chamber,
b) a first field generating device of the ion mobility spectrometer configured to generate an electric field in the reaction chamber for generating a movement of analyte ions which are able to be differentiated by ion mobility spectrometry toward the switchable ion gate,
c) an electrospray device which comprises an electrospray source, wherein the electrospray device is configured to spray a liquid into the reaction chamber as a sprayed-in mist in nebulized form, said liquid being supplied to the electrospray device by the electrospray source and comprising a substance to be analyzed and a solvent,
d) an evaporation device configured to exclusively or predominantly carry out evaporation of the solvent contained in the sprayed-in mist within the reaction chamber, wherein the evaporation device is formed by the first field generating device.

2. The analysis device as claimed in claim 1 wherein the analysis device is embodied without a separate heating device for heating the sprayed-in mist in the reaction chamber.

3. The analysis device as claimed in claim 1 wherein either the electrospray source is embodied as a nanospray source, wherein the liquid to be sprayed in nebulized form is in the form of nanodroplets into the reaction chamber.

4. The analysis device as claimed in claim 1 wherein the electrospray device comprises a voltage source which electrically feeds the electrospray source, wherein the voltage source generates a DC voltage, an AC voltage or a superposition of a DC voltage and an AC voltage.

5. The analysis device as claimed in claim 1 further comprising a negative pressure generating device configured to generate negative pressure in relation to atmospheric pressure, at least in the reaction chamber.

6. A method for analyzing substances by ion mobility spectrometry, comprising:
supplying a liquid containing a substance to be analyzed and a solvent in nebulized form to a reaction chamber of an ion mobility spectrometer by electrospray ionization;
evaporating the solvent within the reaction chamber exclusively or predominantly by an electric field generated in the reaction chamber, wherein kinetic energy is supplied to the droplets of a sprayed-in mist of the electrospray ionization; and
heating said droplets such that the solvent evaporates during the evaporating step.

7. The method as claimed in claim 6 wherein the liquid is dispensed in nebulized form by an electrospray source exclusively or predominantly as a result of the electric field generated in the reaction chamber or in an additional region in front of the electrospray source.

8. The method as claimed in claim 6 wherein the method is carried out under negative pressure in relation to the atmospheric pressure, at least in the reaction chamber.

9. The method as claimed in claim 6 wherein the analyte ions to be analyzed by ion mobility spectrometry are freed from the solvent within the reaction chamber.
